(19) United States
(12) Patent Application Publication
(10) Pub. No.: US 2006/0163916 A1
(43) Pub. Date: Jul. 27, 2006

(54) Wind deflector for a sliding roof system

(75) Inventors: Uwe Escher, Ehningen (DE); Patrick Hoefer, Stuttgart (DE); Wolf-Dietrich Lenk, Asperg (DE); Nicolai Melchger, Wildberg (DE); Ulrich Paetzold, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrylser AG, Stuttgart (DE)

(21) Appl. No.: 10/548,254

(22) PCT Filed: Feb. 26, 2004
(86) PCT No.: PCT/EP04/01899

§ 371 Date: Jan. 18, 2006

(30) Foreign Application Priority Data
Mar. 4, 2003 (DE) 10309395.8

(51) Int. Cl. B60J 7/22

(52) U.S. Cl. 296/217

(57) ABSTRACT

A motor vehicle sliding roof system has a wind deflector which conducts a flow of air, with flow around both sides thereof, over the entire sliding roof opening to prevent rumbling. The efficiency of the wind deflector 3 is improved by having a twist or a torsional distortion, i.e. by various profile sections being torsionally distorted with respect to each other by an angle with respect to each other about a profile axis. The wind deflector is therefore matched to a curvature of the vehicle roof running transversely with respect to the motor vehicle's longitudinal axis. Even in the side region of the sliding roof opening, the system permits a flow which is conducted away over the vehicle roof 9.

### BACKGROUND OF THE INVENTION

The present invention relates to a sliding roof system for a motor vehicle, with a sliding roof opening, which is provided in a vehicle roof curved transversely with respect to a longitudinal axis of the motor vehicle and has a front sliding roof edge and a rear sliding roof edge and a wind deflector which, when the sliding roof is open, is provided in the region of the front sliding roof edge, the wind deflector having over its entire length at least one profile section designed with a wing profile and the profile section being assigned a profile axis arranged transversely with respect to the longitudinal axis of the motor vehicle.

The wind deflector is used to avoid air flowing through the sliding roof opening into the vehicle interior. An air flow of this type causes annoying pressure resonances which are referred to as rumbling. The cause of the rumbling is an eddy which becomes detached at the front sliding roof edge and, depending on the opening length, the roof envelope and the overflow conditions, periodically enters the passenger compartment at the rear sliding roof edge and therefore leads to pressure fluctuations.

Wind deflectors are disclosed in FR-2694522 and U.S. Pat. No. 5,630,640 for motor vehicles, which both run rectilinearly with respect to the longitudinal axis, which intersects the transverse axis at an angle, i.e. are not curved. However, the wind deflector according to U.S. Pat. No. 5,630,640 is of curved or concave design with respect to the transverse axis over its entire length.

An openable roof construction for a vehicle with a roof opening formed in the roof of the vehicle has furthermore been disclosed in DE 101 17 364 A1. The roof opening can be closed by a panel, with a wind deflector being arranged in the vicinity of the front edge of the roof opening in order to deflect an air flow, which is essentially directed rearward over the roof of the vehicle, in relation to the roof opening. The wind deflector is provided with an upper surface which is approached by the flow and has a concave profile in the vicinity of the rear edge of the wind deflector. The wind deflector comprises a main part and a flap-shaped auxiliary deflector. The main part and the auxiliary deflector are at such an angle with respect to each other that a concave profile is again realized. The axis of curvature of this concave surface likewise extends over transversely with respect to the longitudinal axis of the vehicle. The wind deflector is arranged at a distance above the roof of the vehicle, so that an air flow passage is likewise produced along the lower side of the wind deflector.

### SUMMARY OF THE INVENTION

An object of the present invention is to provide a wind deflector in such a manner that the wind deflector can be matched aerodynamically to a particular vehicle body and the air flow is conducted rearward beyond the rear sliding roof edge even in the region of the lateral sliding roof edges.

The foregoing object has been achieved according to the invention by the fact that at least two profile sections are provided which are designed with a wing profile and are torsionally distorted with respect to each other at an angle (α) about the profile axis extending transversely with respect to the longitudinal axis of the motor vehicle. The wind deflector therefore has a torsional distortion which is symmetrical with respect to its center. The effect achieved thereby is that the flow over the width of the wind deflector and therefore over the width of the sliding roof opening is deflected to differing extents. It is possible, by way of the differing deflection precisely in the edge region of the sliding roof opening, to conduct the air flow beyond the rear sliding roof edge.

For this purpose, it is advantageous that at least two profile sections have sides curved concavely and/or convexly to differing extents as a function of the particular distance of the profile axis from the vehicle roof, which sides are torsionally distorted with respect to each other at an angle (α) about the profile axis (3.5) extending transversely with respect to the longitudinal axis of the motor vehicle. This also makes it possible, by means of the differing deflection, to conduct the air flow to different extents in width beyond the rear sliding roof edge even in the region of the lateral sliding roof edges.

The efficiency of the wind deflector is improved by the twisted torsional distortion and by the sides curved concavely and/or convexly to differing extents. This enables the wind deflector to have smaller dimensions or to permit larger sliding roof openings, since the air flow can be conducted rearward further than in the case of wind deflectors which are already known.

Furthermore, it is advantageous that a supporting device of the wind deflector has at least one supporting arm which connects the wind deflector to the vehicle roof, and the supporting arm has at least one turbulator which is designed as a stud, notch or opening and is arranged on one side of the supporting arm.

The sides of the sliding roof opening generally run perpendicularly with respect to the front or rear sliding roof edge. Since the wind deflector can be retracted within the sliding roof opening, its maximum length is the width of the sliding roof opening. In the case of conventional wind deflectors, this still causes at least some of the air flow to flow through the sliding roof opening into the interior, which once again leads to a rumbling.

The rumbling can be completely eliminated by the design according to the invention of the supporting device. The supporting device, which is optimized in terms of flow and has turbulators, assists in disturbing coherent flow detachments in the lateral sliding roof region and therefore the air flow flowing in laterally cannot cause periodic fluctuations in pressure.

An additional possibility, according to one development, is that the sliding roof system is combined in such a manner that the wind deflector has a torsional distortion and sides curved to differing extents or has a supporting device with turbulators. For large sliding roof openings, the combination of a wind deflector which is torsionally distorted in a twisted manner, has sides curved to differing extents and has a supporting device with turbulators is advantageous, since a flow which is deflected further rearwards in accordance with the position with respect to the vehicle roof is promoted.

It is also advantageous for this purpose for the two profile sections to be torsionally distorted by an angle with respect to each other as a function of the particular distance of the profile axis from the vehicle roof. Vehicle roofs are frequently of curved design transversely with respect to the longitudinal axis of the vehicle. As a result, the distance of the profile axis from the vehicle roof has a direct effect on the flow and its range over the sliding roof opening. By means of a torsional distortion of the wind deflector as a function of the distance from the vehicle roof, the air flow is matched individually to the motor vehicle or to the shape of the vehicle roof.

According to one current preferred embodiment of the solution according to the invention, it is finally provided that the length of the wind deflector is 5 to 25% shorter than the front length of the sliding roof edge and the supporting arm at least partially has a cross-sectional profile which is designed as a wing profile. This creates the possibility of arranging the supporting arm not in a plane perpendicular with respect to the vehicle roof, but rather in a plane which encloses an angle of less than 90° with respect to the vehicle roof. In such a position, the supporting arm, in the design according to the invention, assists in conducting the flow over the sliding roof opening. A similar effect is produced by a wind deflector which is of bow-shaped design and is provided over the entire width of the sliding roof opening. Although the flow is no longer deflected vertically upward in the edge region of the sliding roof opening, it has at least one vertical component for spanning the sliding roof opening.

Of particular importance for the present invention is that turbulators which are in the form of depressions, recesses, interfering edges or superelevations are provided on at least one side or in the region of a separation flow line of the wind deflector. These turbulators, which are generally provided on the lower side of the wind deflector, can be very readily combined with the measures which are described above and which increase the reach of the flow over the sliding roof opening. The turbulence generated on the surface of the wind deflector by the interfering edge or depressions consequently has a turbulent boundary layer which, in turn, enables the pressure rise caused by the flow over a convexly curved surface to be better overcome. Thus, a possibly premature, pressure-driven flow detachment is shifted downstream to the rear edge of the profile as what is referred to as a shape-driven flow detachment.

It is furthermore advantageous that the wind deflector can be moved from an operating position with the sliding roof at least partially open, by pivoting about an axis of rotation fixed with respect to the vehicle roof, into a position, in which the sliding roof can be at least partially or completely closed. An additional translatory movement of the wind deflector and a correspondingly complicated mechanism are dispensed with. The wind deflector is in a fixed position with respect to the supporting arm. The axis of rotation is arranged below the plane in which the sliding roof is mounted such that it can move in a translatory manner.

It is also advantageous that a spring and damping element is arranged between the supporting arm and the vehicle roof, the spring and damping element exerting a force on the wind deflector which sets the wind deflector into its operating position and varies the operating position of the wind deflector as a function of the air speed. The supporting arm is prestressed in the active position of the wind deflector via the telescopic spring and damping element.

The flow deflection and the distribution of pressure vary as a function of the air speed at the wind deflector. A force component resulting in a correspondingly variable manner acts on the wind deflector in the direction of the vehicle roof. At higher driving speeds, the wind deflector is therefore continuously lowered from its starting position optimized with respect to the rumbling into a position situated lower with respect to the vehicle roof, which results in a significant reduction in the wind noises. For this, the spring and damping element is configured in such a manner that the wind deflector, in its height with respect to the vehicle roof, is matched dynamically to the driving speed. In all cases, the flow is conducted over the sliding roof opening. At low speeds, the wind deflector rises again after being lowered.

It is furthermore advantageous for the supporting arm of the wind deflector to be pressed down by the sliding roof when the sliding roof is closed. The front edge of the sliding roof moves above the axis of rotation of the wind deflector, during closure of the sliding roof, onto the supporting arms provided on both sides of the wind deflector, as a result of which said supporting arms fold over or pivot forward in the direction of the movement of the sliding roof. The supporting device and the wind deflector are therefore brought into a position below the sliding roof, making it possible for the sliding roof to close.

### BRIEF DESCRIPTION OF THE DRAWINGS

Other objects, advantages and novel features of the present invention will become apparent from the following detailed description of the invention when considered in conjunction with the accompanying drawings.

FIG. 1 is a schematic side view of a wind deflector in an active position above a sliding roof opening;

FIG. 2 is a schmematic front view of a wind deflector;

FIG. 3 is a schematic side view of a wind deflector with depressions;

FIG. 4 is a schematic side view of a wind deflector with an interfering edge below a separation flow line; and

FIG. 5 is a perspective view of a wind deflector above the sliding roof opening.

### DETAILED DESCRIPTION OF THE DRAWINGS

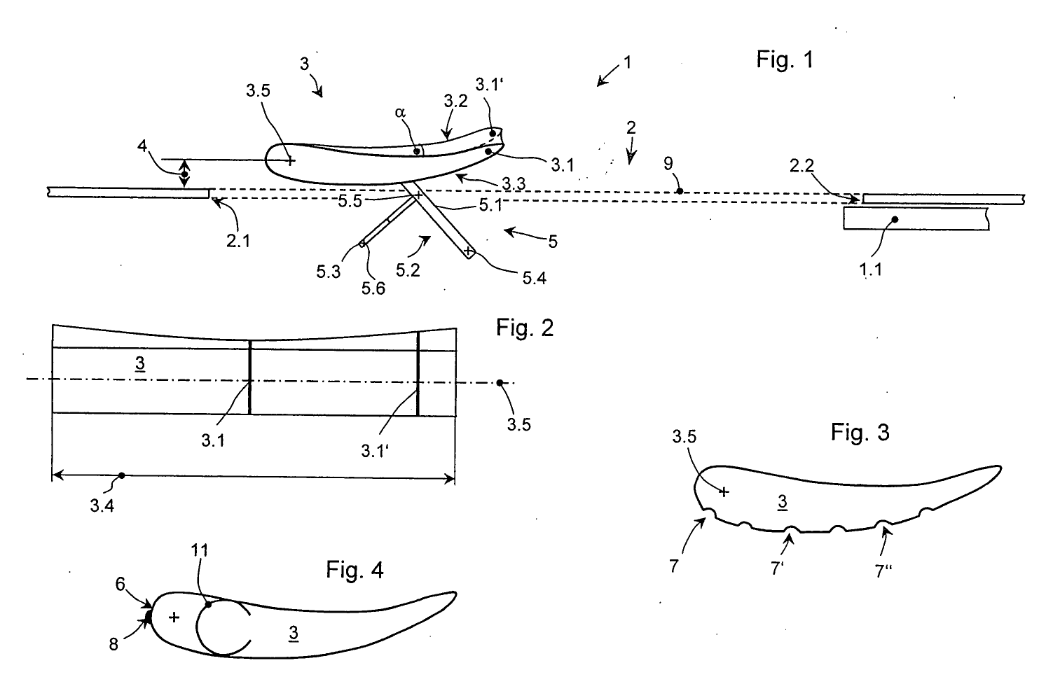

FIG. 1 illustrates a sliding roof opening in a vehicle roof 9, in which a sliding roof 1.1 is mounted displaceably. The sliding roof opening 2 has a front sliding roof edge 2.1 and a rear sliding roof edge 2.2 in the direction of travel of the motor vehicle.

Above the sliding roof opening 2, a wind deflector 3 is fastened rigidly to a supporting arm 5.1 of a supporting device 5. The supporting arm 5.1 is mounted on the vehicle roof 9 in a manner such that it can rotate via a rotation axis 5.4 and is upwardly supported via a prestressed spring and damping element 5.3, which is likewise fastened to the vehicle roof 9. The rotation axis 5.4 is assigned to a hole in a receptacle on the vehicle roof 9 and is fixed in its position. The rotation axis 5.4 cannot be displaced in a translatory manner.

The wind deflector 3 is airfoil-shaped and has a concave upper side 3.2 and a convex lower side 3.3. A profile section 3.1 and a profile section 3.1′ are illustrated in FIG. 1. A profile axis 3.5 runs in the longitudinal direction of the wind deflector 3. The profile section 3.1 is torsionally distorted in relation to a profile section 3.1′ by an angle α about the profile axis 3.5. The size of the angle α is dependent on the distance 4 of the profile axis 3.5 from the surface of the vehicle roof 9, which is of curved design transversely with respect to a longitudinal axis of the motor vehicle.

As illustrated in FIG. 2, a central profile section 3.1 is of flatter design in relation to an outer profile section 3.1′, or is more torsionally distorted in the direction of the vehicle roof 9. The wind deflector 3 therefore has a torsional distortion with at least one flat and two steep positions and is torsionally distorted symmetrically with respect to the center of the vehicle. The torsional distortion runs in a twisted manner over the entire length 3.4 of the wind deflector 3. An incremental length section is designated as the profile section 3.1, 3.1′.

FIG. 3 illustrates a profile section 3.1 of a wind deflector 3 which has turbulators 7, 7′, 7″ configured as depressions on the lower convex side 3.3. The turbulators 7, 7′, 7″ generate a turbulent boundary layer.

According to FIG. 4, the wind deflector 3 has an inner profile 11 which runs parallel to the profile axis 3.5 and is configured as a slit tube. The inner profile 11 is used to stiffen the wind deflector 3. To reduce flow losses, a turbulator 8 in the form of an interfering edge is provided below a separation flow line 6 of the wind deflector 3 and prevents a possibly premature, pressure-driven flow detachment.

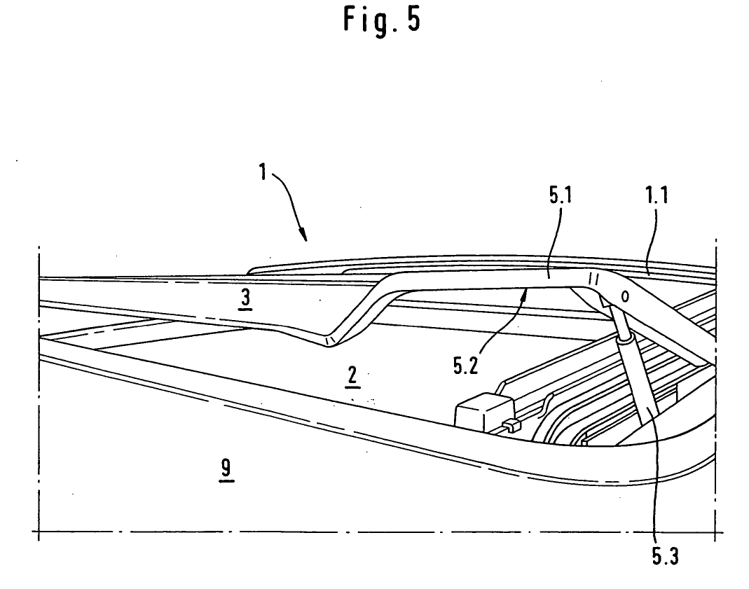

FIG. 5 illustrates a wind deflector 3 according to the invention in the state in which it is fitted on a motor vehicle. The wind deflector 3 protrudes upwardly over the vehicle roof 9 beyond the sliding roof opening 2. The supporting arm 5.1 runs partially over the sliding roof opening 2 and has a turbulator (not illustrated) on its lower side 5.2.

The spring and damping element 5.3 is telescopic and supports the wind deflector 3 upwardly. The supporting arm 5.1 is pressed down by the sliding roof 1.1 when the sliding roof 1.1 is closed, and pivots downward about the profile axis 3.5 illustrated in FIG. 1. In that closing process, the spring and damping element 5.3 retracts and likewise pivots in relation to the wind deflector 3 about an axis 5.5 on the wind deflector 3 and in relation to the vehicle roof 9 about a fixed pivot axis 5.6 on the vehicle roof 9. The sliding roof device 1 has a receptacle (not illustrated) in the region of the front sliding roof edge 2.1, in which the wind deflector 3 and the supporting device 5 pivot during closure of the sliding roof 1.1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-9. (canceled)

10. A motor vehicle sliding roof system comprising, a sliding roof opening provided in a vehicle roof, curved transversely with respect to a motor vehicle longitudinal axis and having a front sliding roof edge and a rear sliding roof edge, a sliding roof, and a wind deflector arranged so that when the sliding roof is open, the wind deflector is in a region of the front sliding roof edge, the wind deflector having over substantially an entire length thereof at least two profile sections with a wing profile associated with a profile axis arranged transversely with respect to the motor vehicle longitudinal axis, wherein the at least two profile sections have a wing profile and are relatively torsionally distortable at an angle about the transversely extending profile axis.

11. A motor vehicle sliding roof system, comprising a sliding roof, a vehicle roof with a sliding roof opening the vehicle roof being curved transversely with respect to a motor vehicle longitudinal axis and having a front sliding roof edge and a rear sliding roof edge, and a wind deflector arranged so that when the sliding roof is open, the wind deflector is in a region of the front sliding roof edge, the wind deflector having over substantially an entire length thereof at least two profile sections with a wing profile and associated with a profile axis arranged transversely with respect to the motor vehicle longitudinal axis, wherein the at least two profile sections have at least one of differently sized cross-sectional areas, concavely curved sides and convexly curved sides to differing extents as a function of a distance of the profile axis from the vehicle roof, the sides being relatively torsionally distortable at an angle about the transversely extending profile axis.

12. The system as claimed in claim 10, whereas the wind deflector includes a supporting device having at least one supporting arm to connect the wind deflector to the vehicle roof, and at least one turbulator configured as one of a stud, notch and opening and arranged on a side of the supporting arm.

13. The system as claimed in claim 11, whereas the wind deflector includes a supporting device having at least one supporting arm to connect the wind deflector to the vehicle roof, and at least one turbulator configured as one of a stud, notch and opening and arranged on a side of the supporting arm.

14. The system as claimed in claim 11, wherein the at least two profile sections are relatively torsionally distortable by an angle as a function of the distance of the profile axis from the vehicle roof.

15. The system as claimed in claim 12, the length of the wind deflector is about 5% to 25% shorter than a front length of the sliding roof edge, and the supporting arm has at least a partial cross-sectional profile configured as a wing profile.

16. The system as claimed in claim 10, wherein turbulators configured as one of depressions, recesses, interfering edges or superelevations are provided at least one side or in a region of a separation flow line of the wind deflector.

17. The system as claimed in claim 10, wherein the wind deflector is arranged to be moveable from an operating position with the sliding roof at least partially open, by pivoting about a rotation axis fixed with respect to the vehicle roof into a position in which the sliding roof can be at least partially or completely closed.

18. The system as claimed in claim 12, wherein a spring-and-damping element is arranged between the at least one supporting arm and the vehicle roof for exerting a force on the wind deflector which sets the wind deflector into an operating position thereof and varies the operating position as a function of the air speed.

19. The system as claimed in claim 12, wherein the at least one at least one supporting arm of the wind deflector is arranged to be pressed down by the sliding roof when closed.
